(19) United States
(12) Patent Application Publication
(10) Pub. No.: US 2023/0407989 A1
(43) Pub. Date: Dec. 21, 2023

(54) Actuator Position Sensing System

(71) Applicant: Bray International, Inc., Houston, TX (US)

(72) Inventors: Ramakrishnan VISWANATHAN, Chennai (IN); Venkateshwaran NATARAJAN, Chennai (IN); Thirugnanasambandan KRISHNAN, Chennai (IN)

(21) Appl. No.: 18/334,216

(22) Filed: Jun. 13, 2023

Related U.S. Application Data
(60) Provisional application No. 63/354,132, filed on Jun. 21, 2022.

(51) Int. Cl. F16K 37/00; F16K 31/122

(52) U.S. Cl. CPC F16K 37/0041; F16K 31/122

(57) ABSTRACT

The embodiments disclosed herein relate to a position sensing system for an actuator of a valve, including a piston of the actuator, wherein the piston is configured to actuate the valve between an open position and a closed position; a sensor including a drum; and a wire wound around the drum at a first end of the wire; wherein the sensor is configured to detect a rotation of the drum; and wherein a second end of the wire is connected to the piston.

### BACKGROUND

### Technical Field

The subject matter generally relates to apparatus and techniques for sensing the position of a valve in flow control systems.

Conventional linear position sensors measure the distance between an object and a point of reference, as well as changes in position. Conventional linear position sensors do this by converting displacement into an electrical output. Selected examples of conventional linear position sensors are provided as follows.

A first example of a conventional linear position sensor, is the electronic valve positioner, which may be commercially available as the FISHER model DVC6000 or DVC6200f. Electronic valve positioners use an electronic sensor to detect valve stem position, a microprocessor to compare that sensed stem position against the control signal by mathematical subtraction (error=position−signal), and then a pneumatic signal converter and relay(s) to send air pressure to the valve actuator.

A second example of a conventional linear position sensor would be a ultrasonic/level sensor, which measures distance by using ultrasonic waves. The sensor head emits an ultrasonic wave and receives the wave reflected back from the target. Ultrasonic/level sensors measure the distance to the target by measuring the time between the emission and reception.

A further example would be magnetostrictive position transducers, which are non-contact devices that detect the position of a magnet. The magnet moves along the length of the sensing element and is attached to the object whose position is to be determined. A current pulse is launched along the conducting wire in the waveguide which generates a circumferential magnetic field around the waveguides as the current pulse travels down the conducting wire. When the magnetic field from the current pulse intersects with the field of the external magnet, the interaction of the fields forms a third field. This causes the waveguide to experience a minute torsional strain or twist. The strain pulse travels at ultrasonic speeds along the waveguide and into a pickup mounted in the head of the instrument.

A final example of a conventional linear position sensor is a proximity sensor, which detect an object without touching it, and they therefore do not cause abrasion or damage to the object. Devices such as limit switches detect an object by contacting it, but proximity sensors are able to detect the presence of the object electrically, without having to touch or contact the sensed object.

Valve and actuator position sensing systems which utilize conventional linear position sensors, examples as provided above, however, have several disadvantages. First, these existing or conventional linear position sensors are not retrofittable in the field to older or prior models of valve systems. Some position sensing systems, such as the magnetostrictive concept described above, requires drilling into the actuator or piston of older valve systems, which is highly undesirable and renders the magnetostrictive concept non-retrofittable. Some conventional linear position sensors that can be placed inside the actuator cannot work with pressurized fluids that could lead to erroneous readings, such as ultrasonic sensors. Further these existing or conventional linear position sensors are often extraneous to the actuator and valve, which may be undesirable in and cannot withstand the potentially extreme environments of the flow control systems. By way of one example, in a typical mining operation, the external environment will have many contaminants and any components externally attached will be subjected to and more prone to abuse or damage. These components include multiple linkages required to connect the valve gate or stem to conventional position sensing devices such as any proximity switches, limit switches, or other sensors, and may be easily damaged in such environments. Thus a need exists for an improved linear position sensor for an actuator of a valve.

### BRIEF SUMMARY

The embodiments disclosed herein relate to a position sensing system for an actuator of a valve, including a piston of the actuator, wherein the piston is configured to actuate the valve between an open position and a closed position; a sensor including a drum; and a wire wound around the drum at a first end of the wire; wherein the sensor is configured to detect a rotation of the drum; and wherein a second end of the wire is connected to the piston.

### BRIEF DESCRIPTION OF THE DRAWINGS

The embodiments may be better understood, and numerous objects, features, and advantages made apparent to those skilled in the art by referencing the accompanying drawings. These drawings are used to illustrate only typical embodiments of this disclosure, and are not to be considered limiting of its scope, for the disclosure may admit to other equally effective embodiments. The figures are not necessarily to scale and certain features and certain views of the figures may be shown exaggerated in scale or in schematic in the interest of clarity and conciseness.

FIG. 1 depicts a front isometric view of an exemplary embodiment of a valve system having a sensor assembly on top of an actuator.

FIG. 2 depicts an enlarged isometric, cutaway view of an exemplary embodiment of a sensor assembly mounted on an actuator.

FIG. 3 depicts a section view of an alternative exemplary embodiment of a sensor assembly connected to the piston head of an actuator.

FIG. 4 depicts a section view of an alternative exemplary embodiment of a sensor assembly connected to the piston rod of an actuator.

### DETAILED DESCRIPTION OF THE EMBODIMENT(S) SHOWN

The description that follows includes exemplary apparatus, methods, techniques, and instruction sequences that embody techniques of the inventive subject matter. However, it is understood that the described embodiments may be practiced without these specific details.

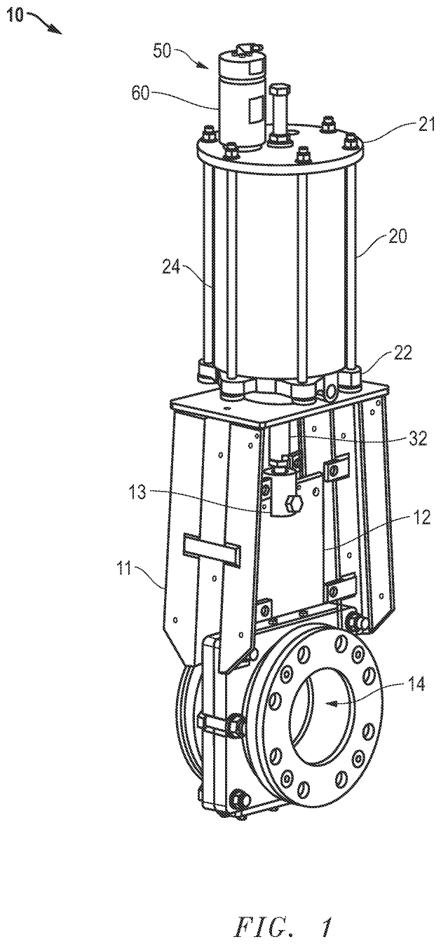

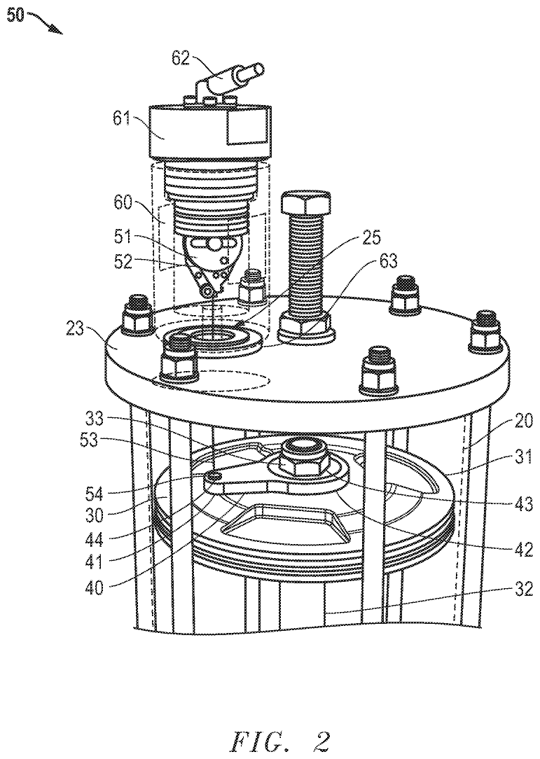

FIG. 1 depicts a front isometric view of an exemplary embodiment of a valve system or assembly 10 having a sensor assembly 50 on top of an actuator 20, wherein the actuator 20 actuates, moves, controls, or manipulates the valve 11 between open and closed positions. The valve assembly 10 includes at least the valve 11, the actuator 20, and the sensor assembly 50. FIG. 2 displays an enlarged, cutaway view of FIG. 1, showing the interior elements or components of the exemplary embodiment of the sensor assembly 50 and the actuator 20.

The valve 11 includes a gate or obturator, or other flow control element 12 which allows or prevents the flow of a media through the valve opening 14 as the actuator 20 actuates the obturator 12 between open and closed positions. In the exemplary embodiments, the actuator 20 may be preferably either a pneumatic or hydraulic actuator. The actuator 20 may have an actuator housing 24 which houses at least one piston 30 which includes a piston head 31 connected to a piston rod 32 at a first end of the piston rod 32, and an actuator cap 23 at a first or top end 21 of the actuator 20 or actuator housing 24. The piston rod 32 is capable of extending and retracting through the bottom 22 of the actuator 20 or actuator housing 24; further the piston rod 32 is connected to the obturator 12 at a second end of the piston rod 32, via a fastener or connection means 13. As depicted in FIG. 1, the piston rod 32 is connected to the obturator 12 via a clevis 13. Other connection or fastening means as known to one of ordinary skill in the art are encompassed by the scope of this disclosure. Providing or reducing pneumatic or hydraulic supply to the actuator 20 will move or actuate the piston 30 and obturator 12. As the piston 30 extends outward through the bottom 22 of actuator 20, the obturator 12 will close or shut the valve opening 14 accordingly. Likewise, as the piston 30 retracts into the actuator 20, the obturator 12 will open, or unblock the valve opening 14 accordingly. As shown in FIG. 1, the valve 11 is in a fully open position, wherein the media can flow through the valve opening 14. In a closed position of the valve 11, no media can flow through the valve opening 14. Although the exemplary embodiments of FIGS. 1-4 depict a knife valve, other types of linear valves 11 such as, including but not limited to: needle valves, globe valves, rising stem ball valves and other valves 11 as known to one of ordinary skill in the art and as actuated by one or more pistons 30, are encompassed by the present disclosure.

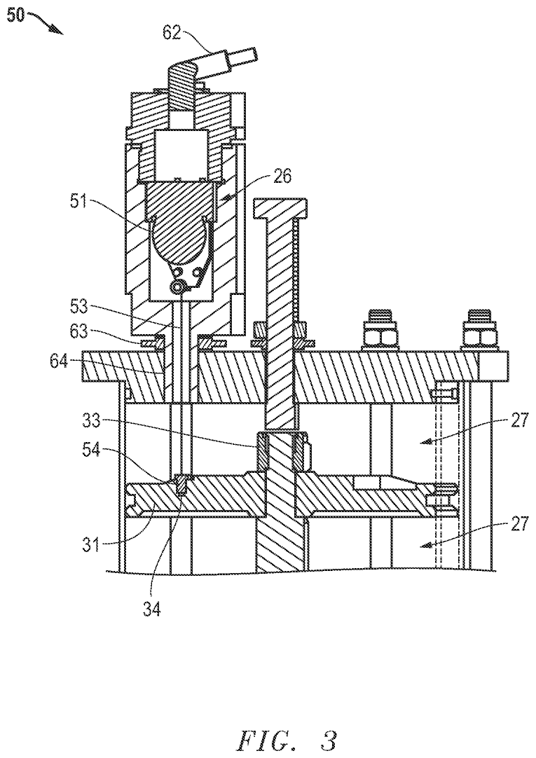

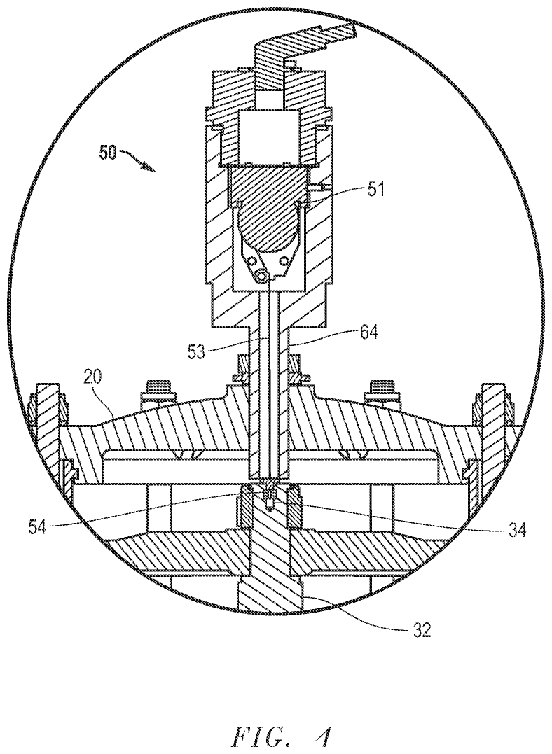

As depicted in FIG. 1 and in further detail in FIG. 2, a sensor assembly 50 is mounted to the actuator 20. The sensor assembly 50 includes at least a sensor housing 60 as mounted or connected to the actuator cap 23 or the top end 21 of the actuator 20, a wire sensor or wire encoder 51, a wire clamping screw 54, and an optional adaptor 40. The adaptor 40 is shown in the exemplary embodiment of FIG. 2; the alternative exemplary embodiments of FIGS. 3 and 4 depict the sensor assembly 50 without the adaptor 40. The housing 60 is a cylindrical housing which is secured to the actuator top 21 or cap 23 and encloses the sensor assembly 50, protecting the interior from the exterior or external environment of the valve system 10. The wire sensor or encoder 51 is housed, contained, or enclosed within the housing 60. The housing 60 may optionally further include a hollow protrusion or extension 64 which extends from the end of the housing 60 and through the actuator top 21. The wire 53 may be at least partially housed or contained within the hollow protrusion 64.

The sensor housing 60 provides sufficient room for mounting the sensor 51 inside the housing 60. The housing 60 further resists or prevents the downward movement of sensor 51, as caused by tensile force subjected to the wire 53 as the wire 53 is pulled from the sensor 51 during actuation of the piston 30. The sensor housing 60 also includes a housing cap 61 which is mounted on top of the sensor 51 and secured to the top of the housing 60 via threading or a threaded joint, or other fastening means. Further, the housing cap 61 is designed to resist the upward movement of sensor 51. For example, if the cap 61 is not installed and if the actuator 20 or piston 30 is pressured to close, there is the dangerous possibility that sensor 51 may be ejected out of the housing 60. This cap 61 prevents the ejection or upward movement of the sensor 51. The components of the sensor assembly 50 are thus internally placed within the housing 60, which prevents and minimizes damage to the sensor assembly 50 and its parts during installation, handling, replacement, or repair, especially from the environment. The housing cap 61 and housing 60 provide an enclosed area, partition, or room to protect the sensor 51 from environmental hazards. The housing 60 also prevents or eliminates the need for multiple external linkages to the sensor assembly 50. The housing 60 is mounted on the actuator cap 23, optionally using threaded joint. An elastomer seal 63 may be fitted or seated between the housing 60 and the actuator cap 23 to avoid or prevent any air leakage during the operation of the valve assembly 10.

A communication device or feedback cable 62 is mounted on the housing cap 61 and is in data communication with the sensor 51. In certain exemplary embodiments, the communication device or feedback cable 62 can transmit or communicate to a controller, computer, or computing unit (not illustrated) via signals or data that represents 0-100% of the valve 11 stroke or piston 30 stroke or via voltage feedback which are indicative of the sensed drum 52 rotations of sensor 51. In certain exemplary embodiments, the signal may be an analog signal between 4-20 mA. In further alternative exemplary embodiments, the communication device 62 may be a wireless means to provide signals, data, information or other feedback to a controller, computer or computing unit for the valve system or assembly 10 and the communication device 62 can be enclosed within the sensor housing 60.

The wire sensor or encoder 51 includes a wire drum or spool 52, around which a wire 53 is wound, spooled or wrapped at one end of the wire. Through an opening 25 in the actuator top end 21 or actuator cap 23, the other or second end of the wire 53 may be connected, affixed, attached, fastened, or secured to a wire clamping device or screw 54. The second end of the wire 53, or the wire clamping device or screw 54, may be mounted onto an adaptor 40 which is connected or adjacent to the piston head 31, (see, e.g. FIG. 2). In alternative exemplary embodiments, the second end of the wire 53 or wire clamping device or screw 54 may be directly inserted, fastened, or connected into an opening, port or hole 34, which may be tapped or threaded, on the piston head 31 (see FIG. 3). In this manner, a portion of the wire 53 may be located in the sensor housing 60, and another portion of the wire may be housed in the actuator housing 24.

In a first exemplary embodiment as shown in FIG. 2, a first end 41 of the adaptor includes an opening, port or hole 44, which may be tapped or threaded, to connect, fix, mount or secure the wire clamping device or screw 54 (or an end of the wire 53) of sensor 51; the other or second end 42 of the adaptor 40 is drilled with a free hole 43 in which the piston rod 32 is inserted therethrough. The adaptor 40 is adjacent to or abuts the piston head 31. A locknut or other fastener 33 may be fastened or threaded onto the piston rod 32 on top of the adaptor 40 and the piston head 31 to secure the adaptor 40 in position. In certain exemplary embodiments, the locknut or fastener 33 may be a nyloc nut. The inclusion of an adaptor 40, as best seen in the exemplary embodiment of FIG. 2, is the preferred exemplary embodiment, as the adaptor 40 eliminates the need for any machining on the piston 30, thus making the sensor assembly 50 a field retrofittable device. The further alternative exemplary embodiments, as depicted in FIGS. 3 and 4, require machining on different parts of the piston 30 and/or piston rod 32 for use with the sensor assembly 50.

In the alternative exemplary embodiment as shown in FIG. 3, the wire clamping device or screw 54 (or the second end of the wire 53) of sensor 51 is directly connected to the piston head 31 without any adaptor 40. The wire clamping device or screw 54 may be directly connected, fixed, secured, or mounted to the piston head 31 via an opening, port, or hole 34, which may be tapped or threaded.

In yet another alternative exemplary embodiment as depicted in FIG. 4, the wire clamping device or screw 54 (or the second end of the wire 53) of sensor 51 is directly connected to the piston rod 32 via an opening 34 machined into the piston rod 32.

The sensor 51 electronic components, including the drum 52, are therefore fully encapsulated in the sensor housing 60 and located on the non-pressurized side or area 26 of the valve system 10 (as compared with potentially pressurized chambers or areas 27 above and below piston head 31 in the actuator 20, see e.g. FIG. 3). The entire sensor assembly or sensor measuring system 50 is therefore incorporated into the cylinder or actuator 20 and optimally protected against external environmental influences.

The sensor 51 may use a wire draw mechanism that is integrated directly with the actuator piston 30, with or without the adaptor 40, to measure the stroke of the piston 30 or piston rod 32. In the depicted embodiments, for the gate or obturator 12 to move from a closed to open position, hydraulic or pneumatic pressure may be applied or supplied on the side of the piston head 31 without the sensor wire 53 connection. For the gate 12 to move from an open to a closed position, the hydraulic or pneumatic pressure may be applied or supplied on the other or opposite side of the piston head 31 (i.e., the side with the sensor wire 53 connection). Accordingly, either side of the piston head 31 can be pressurized. Alternatively, the movement of the piston head 31 (and thus gate 12) can also be effected by the corresponding reduction in hydraulic or pneumatic supply or pressure as desired. The sensor assembly 50 is calibrated for every installation onto an actuator 20. During calibration of the sensor assembly 50, the drum 52 rotation from the beginning of the piston 30 stroke to the end of the piston 30 stroke is calibrated, by way of example, for 4-20 milliamps (wherein in this example, 4 milliamps may indicate or represent a fully closed or fully open position of the gate 12, and 20 milliamps would indicate or represent the opposite fully open or fully closed position of the gate 12). As the piston 30 is actuated to extend through the bottom of the actuator 20, the wire 53 is drawn, unwound or pulled from the wire drum 52. The obturator 12 also progressively or increasingly closes the valve opening 14 as the piston rod 32 extends. When the piston 30 is actuated to retract, the wire 53 is wound, rewound or retracted around the drum 52. As the piston rod 32 retracts, the obturator 12 also increasingly opens or reveals the valve opening 14 to allow flow of the valve media. The winding and the unwinding of the wire 53 from the wire drum or spool 52 and the resulting drum 52 rotation is detected by the wire sensor 51 and converted into an electrical output, such as, by way of example a current or a voltage and compared to the calibrated values. The detection of the rotation of the drum 52 of the wire sensor 51 enables the precise and absolute position or speed tracking of the piston 30, and the valve 11 stroke, at any time.

While the exemplary embodiments are described with reference to various implementations and exploitations, it will be understood that these exemplary embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A position sensing system for an actuator of a valve, comprising
a piston of the actuator, wherein the piston is configured to actuate the valve between an open position and a closed position;
a sensor comprising a drum; and a wire wound around the drum at a first end of the wire; wherein the sensor is configured to detect a rotation of the drum; and wherein a second end of the wire is connected to the piston.

2. The position sensing system according to claim 1, further comprising a sensor housing mounted on the actuator, wherein the sensor housing encloses the sensor and the drum and wherein the wire extends through the sensor housing into the actuator.

3. The position sensing system according to claim 2, further comprising a wire clamping device, wherein the wire clamping device is attached to the second end of the wire.

4. The position sensing system according to claim 3, further comprising a communication device in data communication with the sensor and further wherein the communication device is configured to transmit the rotation of the drum.

5. The position sensing system according to claim 4, wherein the sensor and the drum, are located in a non-pressurized area.

6. The position sensing system according to claim 5, wherein the piston comprises a piston head as connected to a piston rod; and further comprising an adaptor located on top of the piston head.

7. The position sensing system according to claim 6, wherein the wire clamping device is connected to the piston via connecting the wire clamping device to the adaptor.

8. The position sensing system according to claim 7, wherein the adaptor comprises a first end and a second end; wherein the wire clamping device is connected to the adaptor at the first end of the adaptor; and the adaptor is connected to the piston rod at the second end of the adaptor.

9. The position sensing system according to claim 5, wherein the piston comprises a piston head as connected to a piston rod; and wherein the piston head defines an opening; and further wherein the wire clamping device is connected to the piston via inserting the wire clamping device into the opening.

10. A method for determining an unknown position of a valve actuator, comprising the steps of:
providing a sensor having a drum and a wire wound around the drum at a first end of the wire;
connecting a second end of the wire to the piston;
moving the piston between a range encompassing a fully opened position of the valve actuator and a fully closed position of the valve actuator;
observing a rotation of the drum via the sensor, wherein the rotation of the drum is in response to the step of moving the piston; and
determining the unknown position of the valve actuator via the observed rotations of the drum.

11. The method according to claim 10, further comprising the step of enclosing the sensor and the drum in a sensor housing.

12. The method according to claim 11, further comprising the step of converting the observed rotations of the drum into an electrical output via the sensor.

13. The method according to claim 12, further comprising the step of transmitting the electrical output to a computing unit.

14. The method according to claim 13, further comprising the steps of calibrating the drum rotation to the fully opened position of the valve actuator as a first calibrated electrical value; and calibrating the drum rotation to the fully closed position of the valve actuator as a second calibrated electrical value.

15. The method according to claim 14, wherein the step of determining the unknown position of the valve actuator further comprises the step of comparing the electrical output to the first calibrated electrical value and the second calibrated electrical value.

16. The method according to claim 15, further comprising the step of attaching a wire clamping device to the second end of the wire.

17. The method according to claim 16, further comprising the steps of providing an adaptor connected to the piston; wherein the step of connecting the second end of the wire to the piston comprises the step of connecting the wire clamping device to the adaptor.

18. An apparatus to determine the position of an actuator for a valve, comprising
a wire encoder comprising a drum around which a wire is wound at a first end of the wire, and wherein the wire further comprises a second end of the wire;
a piston of the actuator, wherein the piston is configured to manipulate the valve between an open position of the valve and a closed position of the valve;
wherein the second end of the wire is attached to the piston, and further wherein the wire is configured to rotate the drum in response to movement of the piston between the open position of the valve and the closed position of the valve; and
wherein the wire encoder is configured to identify a number of rotations of the drum in response to the movement of the piston.

19. The apparatus according to claim 18, further comprising a pneumatic supply to the actuator and the piston.

20. The apparatus according to claim 18, further comprising a hydraulic supply to the actuator and the piston.
